(19) United States
(12) Patent Application Publication
(10) Pub. No.: US 2026/0174221 A1
(43) Pub. Date: Jun. 25, 2026

(54) Electric Toothbrush System

(71) Applicant: Mariama Bah, Irvington, NJ (US)

(72) Inventor: Mariama Bah, Irvington, NJ (US)

(21) Appl. No.: 18/989,104

(22) Filed: Dec. 20, 2024

(51) Int. Cl. A46B 13/04; A46B 9/04; A46B 13/02; A46B 15/00; A61C 17/02; A61C 17/22; A61C 17/34; A61C 17/36

(52) U.S. Cl. CPC A46B 13/04; A46B 9/04; A46B 13/023; A46B 15/0008; A46B 15/0012; A46B 15/0042; A46B 15/0044; A46B 15/0053; A61C 17/0208; A61C 17/22; A61C 17/3481; A61C 17/36; A61C 2203/00; A61C 2204/002

(57) ABSTRACT

An oral hygiene system comprising a multifunctional electric toothbrush system that provides the following features in a single, transportable device: rinsing and suction, a dynamic toothbrush head, a pressure indication system in the toothbrush head, and music and lighting capabilities. In an embodiment, the multifunctional electric toothbrush system may include an electric toothbrush comprising a toothbrush base and a toothbrush head. The toothbrush has first and second fluid conduits that supply and retrieve fluid to and from a user's mouth through the first end of the toothbrush head. The toothbrush base comprises a pump for delivering fluid from the clean water receptacle to the first conduit opening in end of the toothbrush head (e.g., rinsing), and for delivering fluid through the second conduit opening in the end of the toothbrush head into the waste water receptacle (e.g., vacuuming).

### BACKGROUND OF THE INVENTION

The present disclosure generally relates to an oral hygiene system, and, more particularly, to a multifunctional electric toothbrush that provides the following features in a single, transportable device: rinsing and suction, a dynamic toothbrush head, a pressure indication system in the toothbrush head, and music and lighting capabilities. Wherein, the toothbrush has a rinse mode to provide clean water to a user's mouth after brushing and a suction mode for removing residual toothpaste, liquid, and particulate matter left in the mouth after brushing and/or rinsing.

Toothbrushing is at the core of oral hygiene. Toothbrushing servers three main purposes: 1) to maintain healthy teeth and gums; 2) to remove food particles that may lead to cavities or infection and that are unsightly; and 3) to maintain fresh breath. Its benefits are enhanced with electric toothbrushes as dynamic, motorized movement of toothbrush heads increases a toothbrush's cleaning capabilities. Indeed, to clean teeth, electric toothbrushes provide fast, automatic bristle motion that oscillates rotationally and/or laterally to remove plaque and dislodge foodstuff. These features ease the process of brushing teeth and also effectively remove unwanted buildup. They also benefit users of various ages and abilities, including kids, elderly persons, and patients with disabilities often in hospitals. Given this, motorized toothbrushes have, unsurprisingly, gained significant market share and popularity in recent years. Electric toothbrushes have been the subject of much recent innovation and design activity.

While electric toothbrushes are available in a variety of configurations, most share a common form factor that includes (1) a body housing a motor and battery, and (2) a brushing member removably attached to the body and having a toothbrush head driven by the motor. However, this somewhat rigid form factor and functionality has limitations. For instance, it does not provide a simple way for users to rinse their mouths after brushing is complete. It also requires a sink or toilet bowl for the user to spit post-brush matter into when brushing is complete. These challenges are exacerbated by children, the elderly, or persons with disabilities. For instance, individuals suffering from dementia or Parkinson's disease sometimes clench their teeth down on the toothbrush, which inhibits their ability to brush. Other users have a tendency to overbrush—that is, they press too hard against their teeth and gums which can damage protective enamel and harm otherwise healthy gums. Other users, because of physical limitations, may also experience difficulties bending over and spitting post-brush fluid from their mouths.

Some existing electronic toothbrush devices have attempted to address these issues by including rinsing and vacuuming capabilities, but none have a travel-ready form factor that includes the plethora of features in the instant disclosure. For instance, U.S. Patent Publication No. 2024/0090657 is entitled “Novel Electric Toothbrush System,” and discloses an electric toothbrush system capable of being operated in a rinsing mode to rinse the mouth with clean water, a vacuuming mode for sucking out dirty water left in the mouth after brushing is done. But the clean and dirty water reservoirs are housed in a base station, not within the toothbrush. Similarly, U.S. Patent Publication No. 2020/0054426 is entitled “Electric Toothbrush With Controlled Suction And Irrigation,” and discloses a toothbrush system that delivers clean water to a user's mouth and removes dirty water therefrom through a toothbrush head, but the reservoirs for each are housed outside of the toothbrush itself. U.S. Pat. No. 5,458,563 is entitled “Toothbrushes,” and has a similar construction, i.e., a toothbrush with separate fluid conduits for rinsing and vacuuming, wherein the conduits have respective ends in the toothbrush head and a separate base apart from the toothbrush.

Other prior art toothbrushes have a portable, all-in-one form-factor—see, e.g., U.S. Pat. No. 10,813,442 entitled “Portable, Self-Contained Toothbrush With internal Water, Waste Reservoir And Toothpaste Supply,” and U.S. Patent Publication No. 2012/0288320 entitled “Portable Toothbrush For Delivering And Removing Fluid”—but lack a pressure indication system in the toothbrush head to inform users of clinching or overbrushing. They also lack music and lighting features that makes the act of brushing more relaxing, calming, and enjoyable.

Thus, there is a need for a multifunctional electric toothbrush system packaged in a single, transportable device that provides rinsing and suctioning features for rinsing and cleaning a user's mouth when brushing is complete, and additionally provides a pressure indication system to prevent clinching and overbrushing. The disclosed electric toothbrush system additionally offers many other advantageous features as summarized and described below.

### BRIEF SUMMARY OF THE INVENTION

Embodiments of the present disclosure may comprise an oral hygiene system comprising a multifunctional electric toothbrush that provides the following features in a single, transportable device: rinsing and suction, a dynamic toothbrush head, a pressure indication system in the toothbrush head, and music and lighting capabilities.

In an embodiment, the multifunctional electric toothbrush system may include an electric toothbrush comprising a toothbrush base and a toothbrush head. The toothbrush head comprises a first end that contains toothbrush bristles, and a second end that is removably attached to a first end of the toothbrush base. The toothbrush base comprises a first end that connects to the second end of the toothbrush head and a second end that connects to a storage base.

In an embodiment, the toothbrush has first and second fluid conduits that supply and retrieve fluid to and from a user's mouth through the first end of the toothbrush head. The first conduit has first and second ends, wherein the first end has an opening in the first end of the toothbrush head, and the second end is in a clean water receptacle within the toothbrush base. The second conduit has first and second ends, wherein the first end has an opening in the first end of the toothbrush head, and the second end is in a waste water receptable within the toothbrush base. The clean water receptacle and the waste water receptacle are fluidly segregated from each other. In an embodiment, the toothbrush base comprises a pump for delivering fluid from the clean water receptacle to the first fluid conduit opening in end of the toothbrush head (e.g., rinsing), and for delivering fluid through the second fluid conduit opening in the end of the toothbrush head into the waste water receptacle (e.g., vacuuming).

In an embodiment, the toothbrush base may also comprise a motor and a drive mechanism connected thereto. The drive mechanism is configured to connect with the toothbrush head so as to cause the bristles to vibrate and oscillate rotationally, vertically, and/or laterally to remove plaque and dislodge foodstuff.

In an embodiment, the electric toothbrush may also have a pressure indication system, comprising one or more pressure sensors disposed on the toothbrush head or toothbrush base, and an indicator for notifying the user that pressure on the toothbrush head exceeds a preset limit. The indicator may be a light, sound, increased vibrating intensity, auto-shutoff, or the like. This serves to notify a user when too much pressure is placed on the toothbrush—typically, by clinching or overbrushing—that may cause harm to the user or the device.

In an embodiment, the electronic toothbrush may have a speaker disposed in the toothbrush base or the storage base. The speaker is connected to a power source to optionally play songs, melodies, and/or other sounds to reduce anxiety, and provide calm and enjoyment to the toothbrushing experience. The speaker may be connected to a Bluetooth transmitter to play music or sounds sourced elsewhere.

In an another embodiment, the electric toothbrush has a programable timer to automatically shutoff the brush after a certain amount of time, or to inform the user how long the toothbrush has been active. In another embodiment, the electric toothbrush has smart features that include the capability of connecting to a mobile application that provides the user with brushing data and key insights, like the frequency of brushes, brushing reminders, a brushing schedule, brushing instructions, and the like.

In another embodiment, the toothbrush head bristles are disposed in a crisscross configuration in order to more effectively remove plaque and improve oral hygiene overall.

In another embodiment, the toothbrush base comprises a rechargeable battery for providing power to the electric toothbrush. The storage base is configured to recharge the rechargeable battery when the toothbrush base is received by the storage base.

### BRIEF DESCRIPTION OF THE FIGURES

The accompanying drawings, which are incorporated herein as part of this specification illustrate embodiments of the disclosure, and together with the general and detailed descriptions herein provided, serve to explain and illustrate features of the disclosure. References to the following drawings are in no way limiting and are for illustrative purposes only:

FIG. 1 illustrates a front view an embodiment of the multifunctional electric toothbrush system;

FIG. 2 illustrates a cross-section of an embodiment of the multifunctional electric toothbrush system;

FIG. 3 illustrates a perspective view of an embodiment of the multifunctional electric toothbrush system;

FIG. 4 illustrates a bottom view of an embodiment of the multifunctional electric toothbrush system; and

FIG. 5 illustrates a prospective view of an embodiment of the toothbrush head.

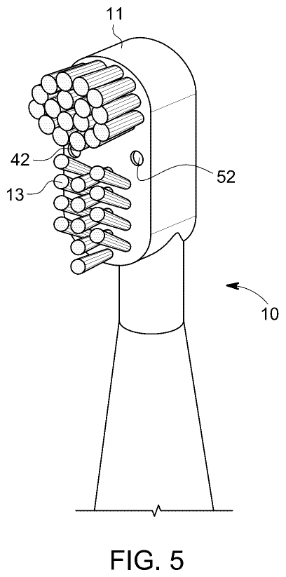

### DETAILED DESCRIPTION OF THE INVENTION

The below disclosure describes an inventive toothbrush system. In the following description, for the purposes of explanation and illustration, numerous details are set forth so as to provide an explanation of the present disclosure. It will be evident to a person of ordinary skill in the art, however, that the exemplary embodiments disclosed herein are illustrative only and not limiting or restrictive.

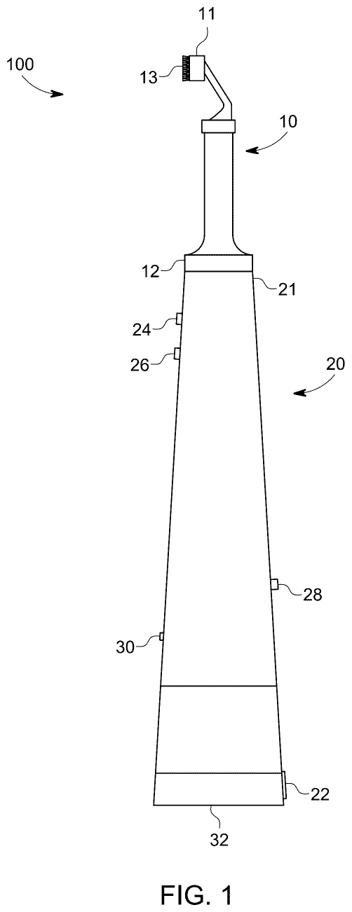

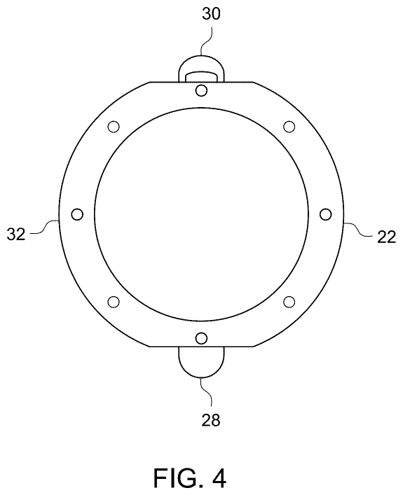

FIG. 1 illustrates an exemplary embodiment of the multifunctional electric toothbrush 100. The electric toothbrush 100 is comprised of a toothbrush base 20 and a toothbrush head 10. The toothbrush head 10 comprises a first end 11 that contains toothbrush bristles 13 attached thereto. The toothbrush bristles 13 may be positioned in a standard flat-trim position such that they are orthogonal to the first end 11 of the toothbrush head 10. The bristles 13 may also include a cris-crossed or cross-hatched configuration, as depicted in FIG. 4. The cris-crossed configuration provides superior cleaning performance because the bristles reach difficult-to-access areas behind the back, and in-between the tight areas of, a user's teeth. Stated another way, the cris-crossed configuration removes plaque from hard-to-reach areas to improve gum health.

Further, the toothbrush head 10 also has a second end 12 that is configured to be removably attached to the toothbrush base 20. The tooth brush head 10 is removably attachable to the toothbrush base 20 as user's will be instructed to replace the toothbrush head 10 every three months or so in order to achieve peak brushing performance. Replacement toothbrush heads 10 can come in a variety of different shapes and sizes to accommodate different users and their respective needs. For instance, some toothbrush heads 10 can have smaller first ends 11 so that they are easier to maneuver. This is especially beneficial for individuals with reduced jaw mobility (i.e., they cannot open their mouths wide), or other ailments. The toothbrush heads 10 may also have bristles 13 with varying firmness, and/or first ends 11 that cause the bristles 13 to rotate or vibrate.

The toothbrush base 20 comprises a first end 21 that is configured to removably connect to the second end 12 of the toothbrush head. The toothbrush base 20 also has a second end 22 that is opposite the first end 21 and is configured to connect to a storage base 80. The toothbrush base 20 may taper outwardly from the first end 21 to the second end 22. The enlarged profile allows for adequate fluid storage and provides an ergonomic, yet compact design for easy handling. The toothbrush base 20 can have any shape or size in keeping with the objectives of the instant disclosure.

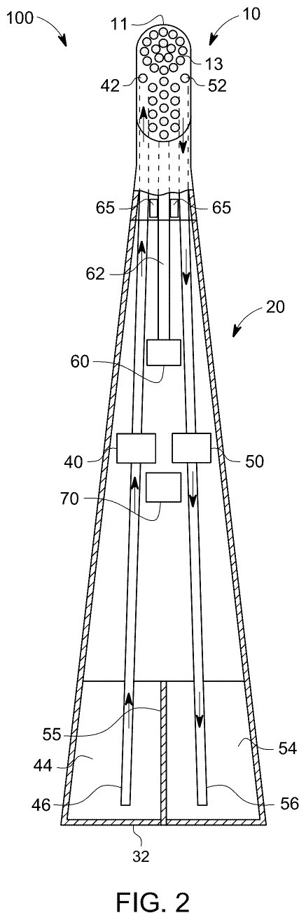

FIG. 2 illustrates the electric toothbrush 100 having a first fluid conduit 40 for transporting clean water to the first end 11 of the toothbrush head 10 from a clean water receptacle 44 in the toothbrush base 20. It also has a second fluid conduit 50 for transporting post-brush fluid from a user's mouth through the first end 11 of the toothbrush head 10 to a waster water receptacle 54 in the toothbrush base 20. The first fluid conduit 40 enables the rinsing feature, and the second fluid conduit 50 enables the vacuum feature.

The first fluid conduit 40 has a first end that ends in an opening 42 in the first end 11 of the toothbrush head 10. It also has and a second end that ends in an opening 46 in the clean water receptacle 44 within the toothbrush base 20. The second fluid conduit 50 has first end that ends in an opening 52 in the first end 11 of the toothbrush head 10. The second fluid conduit 50 also has a second end that ends in an opening 56 in the waste water receptacle 54 within the toothbrush base 20. The clean water receptacle 44 and the waste water receptacle 54 are fluidly segregated from each other by, for example, a partition 55. However, the clean water receptacle 44 and the waste water receptacle 54 may also be segregated by other configurations not depicted herein, including, for example, two separate containers with no adjoining walls.

The size of the clean water receptacle 44 and the waster water receptacle 54 may vary. Each receptacle must be large enough to hold the fluid necessary to allow a single toothbrushing instance. But they need not be the same size. In some instances, having a larger waster water receptacle 54 is beneficial. In some embodiments, the waste water receptacle 54 is larger than the clean water receptacle 44 in order to accommodate the post-brush fluid, which may include water from the clean water receptacle 44, saliva, foodstuffs, and toothpaste.

Both the clean water receptacle 44 and the waste water receptacle 54 are configured to be opened to allow filling and cleaning. Both can be filled with sanitizing fluid for cleaning. The clean water receptacle 44 may also be filled with a mouthwash, antiseptic or otherwise, in order to provide enhanced oral hygiene.

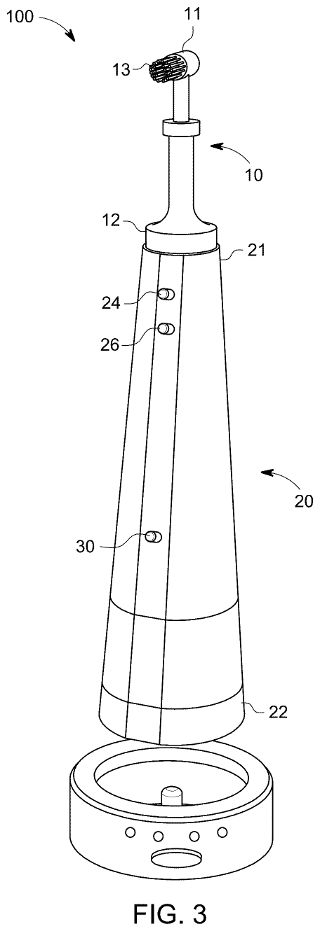

In an embodiment, the rinsing and vacuuming functions are enabled by a pump 70 disposed within the toothbrush base 20. The pump 70 is configured to enable rinsing by delivering fluid from the clean water receptacle 44 to the first fluid conduit opening 42 in the first end 11 of the toothbrush head 10. This can be referred to as the rinsing mode, though this feature can also be used to wet a user's mouth prior to brushing in the first instance. The pump 70 is also configured to enable vacuuming by retrieving fluid from a user's mouth through the second fluid conduit opening 52 in the first end 11 of the toothbrush head 10 and delivering it into the waste water receptacle 54 in the toothbrush base 20. This can operatively be referred to as the vacuuming mode. The rinsing mode is actuated by pressing a rinse button 24, and the vacuuming mode is actuated by pressing a vacuum button 26, as depicted in FIG. 3. The buttons can be positioned anywhere on the toothbrush base 20.

FIG. 2 also depicts a motor 60 and a drive mechanism 62 attached to the motor 60. The drive mechanism is mechanically attached to the first end 11 of the toothbrush head 10 proximate the bristles 13. When actuated, the motor 60 causes the drive mechanism 62 to engage the bristles 13, and/or the portion of the first end 11 of the toothbrush head 10 backing the bristles 13, to move dynamically. Thus, the drive mechanism 62 causes the bristles 13 to vibrate and oscillate rotationally, vertically, and/or laterally to remove plaque and dislodge foodstuff. The motor 60 is connected to an on/off button 28 on the toothbrush base 20, as shown in FIG. 1. When in the on/off button 28 is in an on position, the electric toothbrush is what can be referred to as a brushing mode.

In an embodiment, the brushing mode can have several different configurations. The brushing mode, for instance, may automatically stop after a preset amount of time has lapsed to limit excessive brushing. It may also have different brushing settings. For instance, there can be a massage setting that provides modest bristle 13 vibration so that users can stimulate and clean their gums. Additionally, a normal cleaning setting may provide a preset amount of bristle 13 movement, and a deep cleaning setting may provide an increased intensity in bristle 13 movement for a more robust clean. A section setting may signal that users should clean a different section of their mouths. For instance, after 20-30 seconds of brushing, the motor 60 can be programmed to briefly shutoff before restarting, signaling to the user to clean a different mouth section. The electric toothbrush 100 may also have customizable settings that allows variable speeds and vibration intensities according to a given user's needs and sensitivities.

In an embodiment depicted in FIG. 2, the electric toothbrush may also have a pressure indication system, comprising one or more pressure sensors 65 disposed on or in the toothbrush head 10 or toothbrush base, and an indicator for notifying the user that pressure on the toothbrush head 10 exceeds a preset limit. The pressure sensor 65 may optionally be ring-shaped and disposed over the drive mechanism 62, so that when excessive force/pressure is applied on the toothbrush head 10—by for example, overbrushing or clinching—the pressure sensor 65 will detect it and signal the indicator. In an embodiment, the indicator is a light 30 in the toothbrush base 20, as depicted in FIG. 3. But the indicator is not so limited. The indicator may be a light, a sound, an increased vibration intensity, an auto-shutoff of the motor, or the like. The indicator serves to notify a user when too much pressure is placed on the toothbrush—typically, by clinching or overbrushing—that may cause harm to the user or the device. In embodiments where the indicator is a light 30, the light 30 can be positioned anywhere on the toothbrush base 20 and can have any shape or size that is consistent with the objectives of the present disclosure.

The indicator may vary. For instance, in an embodiment, upon sensing high pressure, the electric toothbrush 100 can be configured to slowly increase its vibration or brushing intensity, providing a gentle prompt to open wider without causing discomfort. Likewise, the pressure sensor 65 can have any shape, size, or location in keeping with the objectives of the present disclosure.

In an exemplary use case, an elderly user may begin brushing his teeth, and then suddenly and inadvertently clinch down onto the toothbrush head 10. That action places increased force/pressure on the toothbrush head 10 that would transfer through the drive mechanism 62 and register with the pressure sensor 65. If the pressure on the pressure sensor 65 exceeds a preset limit, then the indicator light 30 will flash/glow red, signaling that unwanted clinching or overbrushing is occurring and should cease. The user will then know to un-clinch his jaw before continuing to brush. Once the pressure is released, that too will register with the pressure sensor 65, and the light 30 will turn off.

As depicted in the embodiment in FIG. 4, the electronic toothbrush 100 may have a speaker 32 disposed in the toothbrush base 20 or the storage base 80. The speaker 32 is configured to play songs, melodies, and/or other sounds to reduce anxiety, and provide calm and enjoyment to the toothbrushing experience. The speaker 32 may optionally be connected to a Bluetooth transmitter to play music or sounds sourced elsewhere. The speaker 32 can optionally be disposed anywhere on the toothbrush base 20.

In another embodiment, the electric toothbrush 100 has smart features that include the capability of connecting to a mobile application that provides the user with brushing data and key insights. The data may include information regarding the frequency of brushes, the duration of brushes, whether overbrushing or clinching occurred during brushes, brushing reminders, a brushing schedule, brushing instructions, and/or the like. The app could also gamify brushing by offering rewards for consecutive brushes without missing scheduled sessions. The gamification could incentivize brushing for individuals that sometimes forget, thereby increasing brushing frequency and improving their oral hygiene.

In another embodiment, the toothbrush base 20 comprises a rechargeable battery (not shown) for supplying power to the electric toothbrush 100, including to the motor 60, pump 70, and speaker 32. The storage base 80 is configured to recharge the rechargeable battery when the toothbrush base 20 is received by the storage base 80.

The compact, all-in-one form factor of the disclosed embodiment allows for increased portability compared to prior art toothbrushes that are mechanically tethered to a storage base having clean and dirty water receptacles.

This disclosure is to be regarded as illustrative rather than restrictive. Although the inventive material in this disclosure has been described in detail along with some of its technical advantages, it will be understood that various changes, substitutions, and alterations may be made to the detailed embodiments without departing from the broader spirit and scope of the disclosure as set forth in the following claims. It is further understood that the above description is intended to be illustrative, and neither restrictive or limiting. Many other embodiment will be apparent to those of ordinary skill in the art upon reading and understanding the above description. Although the present disclosure has been described with reference to specific embodiments, it is noted that the disclosure is not limited to the embodiments described or depicted herein. Rather, embodiments of the disclosure can be practiced with modification and alteration not herein mentioned, but otherwise within the spirit and scope of the claims herein provided.

What is claimed is:

1. An electric toothbrush for improved oral hygiene, comprising:
a toothbrush base and a toothbrush head, the toothbrush base having a first end that connects to the toothbrush head and a second end that connects to a storage base, and the toothbrush head having a first end that contains bristles, and a second end that is removably attached to a first end of the toothbrush base, and wherein the toothbrush head is removably attached to the toothbrush base;
a first fluid conduit and a second fluid conduit, wherein the first fluid conduit has a first end that has an opening proximate the bristles and a second end in a clean water receptacle in the toothbrush base, and the second fluid conduit has a first end that has an opening proximate the bristles and a second end at a waste water receptacle in the toothbrush base;
a pump disposed in the toothbrush base for delivering fluid from the clean water receptacle to the first fluid conduit opening for rinsing a user's mouth, and for retrieving fluid from the user's mouth at the second fluid conduit opening and vacuuming it into the waste water receptacle;
a pressure indication system comprising:
one or more pressure sensors disposed on the toothbrush head or toothbrush base for determining whether pressure applied to the toothbrush head exceeds a preset limit, and
an indicator for notifying the user that pressure on the toothbrush head exceeds the preset limit to prevent clinching or overbrushing, or both;
a motor and a drive mechanism connected to the motor, wherein the drive mechanism is configured to connect with the toothbrush head so as to cause the bristles to vibrate and oscillate at least one or more of rotationally, vertically, or laterally to remove plaque and dislodge foodstuff; and
a speaker for playing music, sounds, or spoken word to reduce anxiety during brushing.

2. The electric toothbrush of claim 1, wherein the indicator is a light on the toothbrush base or the toothbrush head that is actuated when the pressure sensor detects pressure that exceeds a preset limit.

3. The electric toothbrush of claim 1, wherein the indicator is an automatic shutoff for turning off the motor that is actuated when the pressure sensor detects pressure that exceeds a preset limit.

4. The electric toothbrush of claim 1, wherein the indicator is a sudden increase in a speed of the motor and the drive mechanism that is actuated when the pressure sensor detects pressure that exceeds a preset limit.

5. The electric toothbrush of claim 1, wherein the speaker is connected to a Bluetooth transmitter.

6. The electric toothbrush of claim 1, wherein the speaker is disposed in at least one of the toothbrush base or the storage base.

7. The electric toothbrush of claim 1, a rechargeable battery disposed within the toothbrush base, and wherein the storage base is configured to recharge the rechargeable battery when the toothbrush base is received by the storage base.

8. The electric toothbrush of claim 1, wherein the bristles have a crisscross configuration.

9. The electric toothbrush of claim 1, wherein toothbrush base tapers outward from the toothbrush base first end to the toothbrush base second end, providing an enlarged toothbrush base profile.

10. The electric toothbrush of claim 1, wherein the electric toothbrush has a programable timer.

11. An electric toothbrush for improved oral hygiene, comprising:
a toothbrush base and a toothbrush head, the toothbrush base having a first end that connects to the toothbrush head and a second end that connects to a storage base, and the toothbrush head having a first end that contains bristles, and a second end that is removably attached to a first end of the toothbrush base, and wherein the toothbrush head is removably attached to the toothbrush base;
a first fluid conduit and a second fluid conduit, wherein the first fluid conduit has a first end that has an opening in the bristles and a second end in a clean water receptacle in the toothbrush base, and the second fluid conduit has a first end that has an opening in the bristles and a second end at a waste water receptacle in the toothbrush base;
a pump disposed in the toothbrush base for delivering fluid from the clean water receptacle to the first fluid conduit opening for rinsing a user's mouth, and for retrieving fluid from the user's mouth at the second fluid conduit opening and vacuuming it into the waste water receptacle;
a pressure indication system comprising:
one or more pressure sensors disposed on the toothbrush head or toothbrush base for determining whether pressure applied to the toothbrush head exceeds a preset limit, and
an indicator for notifying the user that pressure on the toothbrush head exceeds the preset limit to prevent clinching or overbrushing, or both;
a motor and a drive mechanism connected to the motor, wherein the drive mechanism is configured to connect with the toothbrush head so as to cause the bristles to vibrate and oscillate at least one or more of rotationally, vertically, or laterally to remove plaque and dislodge foodstuff;
a speaker for playing music, sounds, or spoken word to reduce anxiety during brushing; and
wherein toothbrush base tapers outward from the toothbrush base first end to the toothbrush base second end, providing an enlarged toothbrush base profile.

12. The electric toothbrush of claim 11, wherein the indicator is a light on the toothbrush base or the toothbrush head that is actuated when the pressure sensor detects pressure that exceeds a preset limit.

13. The electric toothbrush of claim 11, wherein the indicator is an automatic shutoff for turning off the motor that is actuated when the pressure sensor detects pressure that exceeds a preset limit.

14. The electric toothbrush of claim 11, wherein the indicator is a sudden increase in a speed of the motor and the drive mechanism that is actuated when the pressure sensor detects pressure that exceeds a preset limit.

15. The electric toothbrush of claim 11, wherein the speaker is connected to a Bluetooth transmitter.

16. The electric toothbrush of claim 1, wherein the speaker is disposed in at least one of the toothbrush base or the storage base.

17. The electric toothbrush of claim 11, a rechargeable battery disposed within the toothbrush base, and wherein the storage base is configured to recharge the rechargeable battery when the toothbrush base is received by the storage base.

18. The electric toothbrush of claim 11, wherein the bristles have a crisscross configuration.

19. The electric toothbrush of claim 11, wherein the electric toothbrush has a programable timer.

20. The electric toothbrush of claim 11, wherein the electric toothbrush is configured to connect to a mobile application that provides the user with toothbrushing data.
